(19) United States
(12) Patent Application Publication
(10) Pub. No.: US 2009/0041884 A1
(43) Pub. Date: Feb. 12, 2009

(54) COVER FOR CLOSING A MOULDING MOULD USING CLOSURE MOULD TECHNOLOGY, ESPECIALLY RESIN INFUSION OR INJECTION

(75) Inventors: Gerard Joly, Creutzwald (FR); Eric Deneux, Metz (FR)

Correspondence Address: CANTOR COLBURN, LLP, 20 Church Street, 22nd Floor, Hartford, CT, 06103, US

(73) Assignee: CHOMARAT COMPOSITES, Paris (FR)

(21) Appl. No.: 12/162,632

(22) PCT Filed: Feb. 13, 2007
(86) PCT No.: PCT/FR2007/050791

§ 371 Date: Sep. 26, 2008

(30) Foreign Application Priority Data
Feb. 14, 2006 (FR) 0601256
Apr. 26, 2006 (FR) 0651428

(51) Int. Cl. B29C 45/04

(52) U.S. Cl. 425/443

(57) ABSTRACT

Cover for closing a moulding mould using closure mould technology such as resin infusion or injection including a form-maintaining frame, having a plurality of inflatable wedges, which are arranged on at least part of the circumference thereof, and mounted in a removable manner.

### TECHNICAL FIELD OF THE INVENTION

The invention relates to the field of the manufacture of composites by moulding methods employing closed moulds. It may relate to resin infusion or injection processes. It may also relate to processes using resin prepreg reinforcements. It relates more specifically to equipment used during the implementation of the moulding method. More precisely, it relates to a cover for closing the mould during the introduction of the resin. The invention relates more specifically to a novel structure of this type of cover, which serves in particular to facilitate the operations of placement on the mould.

In the rest of the description, the invention will be described more particularly for infusion processes, but without being limited to this technique alone, with the understanding that it can be transposed to mouldings by resin injection, or by curing of prepreg reinforcements.

### BRIEF DESCRIPTION OF RELATED ART

In general, resin infusion moulding processes involve a plurality of steps including the placement of fibrous reinforcing elements on the form of a mould. The mould is then closed by a flexible cover allowing the controlled passage of a resin that is infused into the reinforcement to occupy it completely, and then to be cured, in order to yield a rigid part. The resin is propagated by the application of a vacuum at certain points of the cover, to which the resin introduced into the mould moves automatically.

In practice, the mould cover can be made from a sealed film, which is then removed after moulding. It is clear that the use of a disposable film generates waste which complicates the overall implementation of the method. It is also known how to use lids formed from a thicker cover, but reusable. It is clear that the tightness is a crucial parameter for the satisfactory conduct of the infusion process, because the vacuum applied must attract the infusing resin, and not air issuing from leaks. This tightness must be maintained over time, if the same cover for closing the mould is to be reused several times in succession.

Today, the tightness is maintained by the use of a cover that is relatively thick, and typically based on silicone.

The thickness, and hence the total weight of the cover, generates difficulties in handling during the placement of the cover on the mould. This is because the materials employed commonly have a thickness of about 5 mm, and are difficult to handle when parts several metres long are concerned, such as ships' hulls in particular. More precisely, the high weight of existing covers complicates the operations of placement on the mould. A large number of operators is required to secure the edges of the cover during its positioning on the mould. It is therefore one object of the invention to facilitate operations for installing the cover on the mould, in particular by reducing manual operations.

Another problem resulting from the high thickness of the cover is the difficulty caused by its transport, particularly when the mould is large. This is because mould closure covers manufactured today are formed by the assembling of various elementary portions, cut out to shape on the mould and then joined together. Such a cover can only be transported in its final geometry, that is with a size considerably larger than that of the mould.

One solution to this problem has been described in document U.S. Pat. No. 6,551,091. For this purpose, the cover is equipped on its whole circumference with inflatable wedges which form a frame imparting to the cover a shape enabling it to be placed easily on the mould. However, these wedges are welded to the cover, and therefore constitute added thicknesses when they are deflated. Hence, they make the folding of the cover difficult, and increase the risk of the formation of creases in the cover, during the storage thereof. The folds are detrimental to the visual quality of the subsequent mouldings.

### SUMMARY OF THE INVENTION

The invention permits the easy transport and storage of a cover forming a mould lid, particularly in view of its subsequent reuse.

The invention therefore relates to a cover for closing a moulding mould by resin infusion. In a manner known per se, this cover comprises a form-maintaining frame, comprising a plurality of inflatable wedges, arranged on at least part of its circumference.

According to the invention, this cover is characterized in that it comprises means for removably joining the frame to the cover.

In other words, the invention consists in equipping a prefabricated cover with a set of inflatable elements which, when they are inflated, define the contour of the cover, while maintaining the shape thereof This frame therefore roughly matches the shape of the contour of the mould, so that it maintains the cover in position automatically without the need for operators to secure it firmly during its placement. The frame therefore plays an “exoskeleton” role defining the general shape of the cover, which is thereby substantially stretched between the various portions of the frame. The frame is installed on the cover just before its placement on the mould, and can be withdrawn after use of the cover, to avoid disturbing the folding and storage operations.

Thanks to this frame, the number of handling operations is reduced, and other further advantages are obtained. This is because insofar as the form-maintenance of the cover is no longer provided by its thickness and its own stiffness, but mainly thanks to the characteristic frame, it is possible to employ much thinner and therefore lighter materials than those employed today. A further advantage resides in the fact that the cover thereby obtained is foldable and therefore much more easily transportable, because of its smaller size.

In practice, the joining means may be distributed on all or part of its circumference, and for example may be formed from straps fastened to the cover. In this case, advantageously, the straps may form two flaps suitable for cooperating together at their ends. In other words, these straps immobilise each wedge when the frame is to be fastened. In this case, the wedges may have some latitude of movement within the straps, thereby allowing an adjustment if necessary. These straps are detached in order to disengage the frame from the cover.

Advantageously, the wedges may be preformed, so as to adopt the optimal configuration by the integration of the cover in the mould.

In practice, the frame may extend on all or part of the circumference of the cover, but also include optional wedges transversally connecting two regions of the circumference of the cover. These additional wedges prevent the circumference of the cover from separating excessively, and therefore maintain the contour of the cover at the dimensions of the mould. These additional wedges may extend in a straight direction above the cover, or may even be joined to the cover in which case they match the curvature thereof.

In practice, the wedges may be connected pneumatically, so as to inflate them simultaneously. The wedges may also be pneumatically independent, if it is advantageous to inflate them sequentially to obtain a gradual deployment of the shape of the mould.

### BRIEF DESCRIPTION OF THE FIGURES

The manner of implementing the invention, and the advantages thereof, will appear clearly from the description of the embodiment that follows, in conjunction with:

FIGS. 1-2 which show a rough perspective view of a cover according to the invention, shown respectively before the placement of the frame and in a configuration ready to be placed on the mould.

### DETAILED DESCRIPTION OF THE INVENTION

The cover (1) shown in the figure has a voluminous shape, enabling its placement in the mould (2) having a matching shape, in which the various textile layers (3) and other elements necessary for the production of the moulded part, have already been placed. This cover (1) consists mainly of a membrane (4) matching the shape of the mould (2). It can be made in various ways. Thus, the cover may be obtained by thermoforming, so that it is in a single piece, a three-dimensional shape adapted to the shape of the mould. It may also be obtained by joining operations for assembling various portions corresponding to the various zones of the mould. Thanks to the characteristic frame, this membrane can be made from a relatively thin material, typically thinner than one millimetre, which should be compared to the thicknesses of about 5 mm corresponding to the covers known today.

The materials employed may typically be based on thermoplastics, advantageously selected for their chemical resistance to the products employed during the resin infusion. In particular, these materials have good impermeability to solvents, and typically to styrene.

According to the invention, the cover (1) comprises a frame (10) consisting of a plurality of wedges (11-16), advantageously arranged on the cover (1). More precisely, and as shown in the figure, a plurality of these wedges (11-14) are arranged on the circumference of the cover (1), close to the peripheral zone (18), resting on the rim (19) of the mould. More precisely, the wedges (11-14) are joined to the cover by appropriate means, to provide a reversible mechanical linkage between the wedge and the cover.

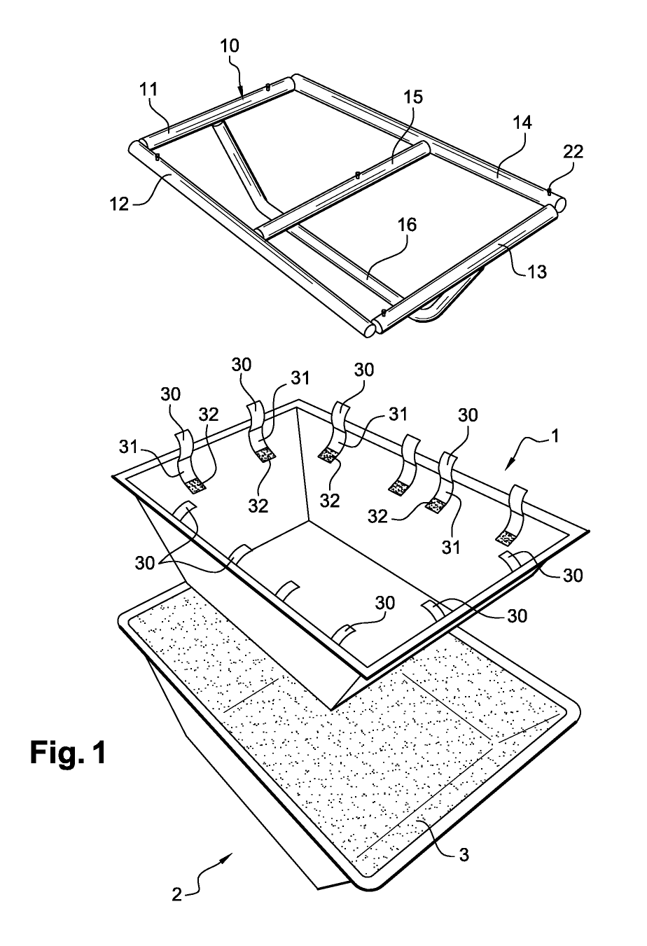

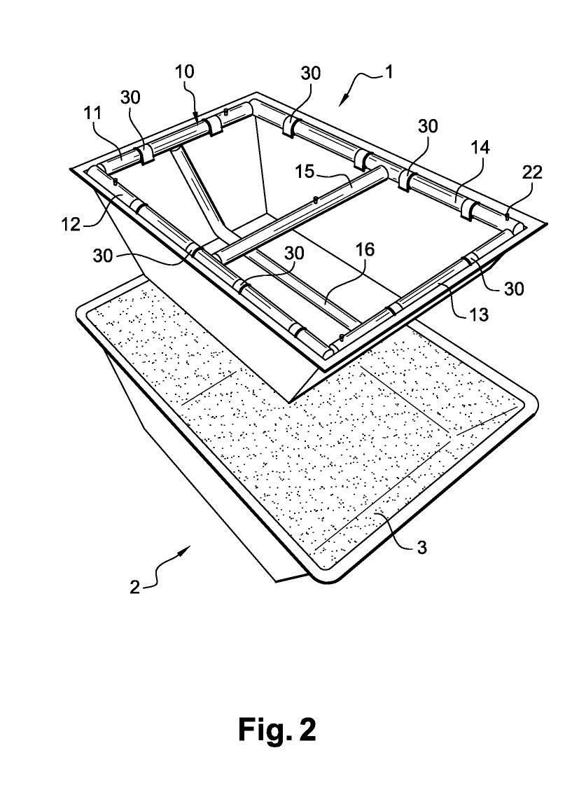

Thus, as shown in FIG. 1, the joining means consists of straps (30, 31), which may be formed from a strip of coated textile for example. This strip is stitched, or advantageously welded to the upper surface of the cover. The ends of the straps are provided with fastening means (32) of the Velcro® type. These straps are distributed uniformly on the zones of the cover requiring them.

In another alternative, the Velcro® type fastening zones may be directly provided on the wedges and the cover.

In practice, each of the wedges may consist of a sealed envelope, suitable for being inflated via an inflation valve (22). It is also possible for the inflatable wedge to be formed from a duct, which does not need to have any particular tightness, and into which an element capable of being inflated is inserted. It is simply necessary for the duct to be non-extensible.

In the embodiment shown, the frame (10) comprises not only a set of wedges (11-14) distributed on the circumference of the cover, but also transversal wedges.

A first wedge (15) connects the two portions in the two large opening sides of the cover. This wedge (15) is removably joined to the cover and/or, as shown, only to the wedges (12-14). When the cover (1) is in a configuration for placement in the mould (2), the wedge (15) therefore prevents the large sides of the cover from separating excessively.

Other wedges, like the wedge (16) shown in the figure, may be positioned to maintain the form of the cover. More precisely, the wedge (16) is distinguished from the wedge (15) in that it remains in contact with the upper surface of the cover (1) along its whole length. This wedge (16) can therefore be prepared in the same way as the peripheral wedges (11-14).

According to another feature of the invention, it is possible to connect the various wedges pneumatically or not, in order to inflate them using a single compressed air source, or conversely, to inflate them separately whenever necessary. It is also possible to combine a plurality of wedges together, to form various separately inflatable groups.

The cover according to the invention has the major advantage of being producible from a thinner and therefore lighter material than those employed today. Thus, when the various wedges are removed from the cover, it retains a capacity to be folded, thereby considerably facilitating its transport. The installation and deployment in the mould can take place easily, after the inflation of the various wedges which serve to deploy the cover in its nearly final shape. The frame (10) formed by the various wedges (11-16) thereby allows easier handling, by a limited number of operators, or even by mechanized handling means, for its installation and placement in the mould. The cover according to the invention therefore procures major advantages in terms of weight, size, ease of transport, handling during the installation in the mould, and manpower.

1. Cover for closing a moulding mould using closure mould technology such as resin infusion or injection, comprising:
a form-maintaining frame( comprising a plurality of inflatable wedges, which are arranged on at least part of the circumference thereof, and
means for removably joining the frame to the cover.

2. Cover according to claim 1, wherein the joining means are distributed on all or part of a circumference.

3. Cover according to claim 2, wherein the joining means are formed by straps fastened to the cover.

4. Cover according to claim 3, wherein the straps form two flaps suitable for cooperating together at ends.

5. Cover according to claim 1, wherein the frame also comprises wedges transversally connecting two regions of a circumference.

6. Cover according to claim 1, wherein the wedges are pneumatically connected.

7. Cover according to claim 1, wherein the wedges are formed from a sealed duct.

8. Cover according to claim 1, wherein the wedges are formed from a non-extensible duct accommodating an inflatable element.

9. Cover according to claim 1, wherein the wedges are preformed.
